(19) United States
(12) Patent Application Publication
(10) Pub. No.: US 2019/0040302 A1
(43) Pub. Date: Feb. 7, 2019

(54) BIOFUELS FOR ENHANCING PRODUCTIVITY OF LOW PRODUCTION WELLS

(71) Applicant: HK IP LLC, Greenwood Village, CO (US)

(72) Inventors: Rob McNaughton, Greenwood Village, CO (US); Nick Koster, Greenwood Village, CO (US); Wes Aaron, Greenwood Village, CO (US)

(21) Appl. No.: 16/075,389

(22) PCT Filed: Feb. 6, 2017
(86) PCT No.: PCT/US2017/016726

§ 371 Date: Aug. 3, 2018

Related U.S. Application Data
(60) Provisional application No. 62/291,415, filed on Feb. 4, 2016.

(51) Int. Cl. C09K 8/58; C09K 8/68; C09K 8/74; C09K 8/80

(52) U.S. Cl. CPC C09K 8/58; C09K 8/68; C09K 2208/26; C09K 8/80; C09K 8/74

(57) ABSTRACT

Described herein are environmentally acceptable fluid compositions, and methods and systems of using the fluids for restoring or enhancing hydrocarbon flow from a well bore. In some embodiments the fluids can be used to decrease the viscosity of a high viscosity hydrocarbon such as heavy crude oil. In other embodiments, the fluids may be used to aid in releasing a hydrocarbon from a geologic formation. In other embodiments, the fluids may be used to restore flow from a wellbore located at or near a geologic formation with a significant concentration of clay. In some embodiments, the disclosed fluids may be used with one or more viscosity-modifying compounds. The disclosed compositions may help decrease the concentration of water within the formation while increasing the concentration of methanol within the formation, which may aid in restoring cracks and fissures in the formation, increasing the size of the cracks and fissures, or increasing the number of cracks and fissures within the formation.

### CROSS REFERENCE TO RELATED APPLICATIONS

This application claims benefit of priority pursuant to 35 U.S.C. § 119(e) to U.S. Provisional Patent Application No. 62/291,415, filed on Feb. 4, 2016, entitled “Biofuels For Enhancing Productivity Of Low Production Wells,” the content of which is hereby incorporated by reference herein in its entirety.

### FIELD

The methods, compositions, and systems relate to increasing production from oil and gas wells that may have reduced productivity due to water damage (for example, due to absorption of water by swelling clays and/or fines migration). The disclosed methods, compositions, and systems may enhance productivity from wells to provide for long-term economically sustainable productivity, and do so in an environmentally friendly manner.

### BACKGROUND

Some crude oil is highly viscous under normal conditions. In many cases, highly viscous oil may not flow easily from the surrounding reservoir into the production wellbore. In some cases, high viscosity oil may not flow, or flow poorly at ambient temperatures. Enhanced oil recovery (EOR) may be used to aid in extracting oil with high viscosity. Generally, three techniques are used for EOR: thermal recovery, gas injection, and chemical injection. EOR may be used to increase the percentage of a reservoir's original oil that can be extracted. EOR can be performed with a single wellbore, or more than one. Where EOR is performed with a single wellbore, the method may proceed in two stages, an injection stage and a production stage. This may be referred to as “huff and puff.” In some embodiments, injected gas or fluid may be allowed to a soaking or incubate in the formation for a period of time before the oil is pumped out. Other embodiments use two (or more) wells: an injection well, and a production well.

Gas injection EOR, which is the dominant EOR used in the United States, uses gases such as natural gas, nitrogen, or carbon dioxide (CO₂). Gas injection may also be referred to as “miscible flooding,” describing the introduction of miscible gases into an oil reservoir. CO₂ is the most commonly used gas because of its low cost and ability to reduce viscosity.

Thermal injection involves the introduction of heat into an oil reservoir. In most cases, the injection of steam causes the oil to heat and expand, lowering its viscosity and allowing it to migrate to a production well. In some cases, the use of steam for thermal injection is problematic where the formation contains large amounts of clay or other hygroscopic material that may tend to trap the water and prevent migration of the oil. In general, thermal injection techniques have temporary effects, with the beneficial changes dissipating over time as the temperatures return to pre-injection levels.

Chemical injection generally involves injection of one or more compounds that aid in altering the chemical properties of either the oil or the formation. In many cases, chemical enhanced oil recovery may involve the use of polymers, alkaline or caustic solutions, and/or surfactants to enhance recovery of oil from the reserve. For example, alkaline solutions may react with the oil to form a surfactant, which then aid in enhancing recovery by reducing the interfacial tension between oil and water that may be present in the formation. In some cases, the use of chemical enhanced oil recovery may be limited due to the cost of the ingredients. Moreover, because the injected ingredients are often reactive with oil and material in the formation, care must be taken to avoid damaging the formation.

Hydraulic fracturing, or “hydraulic fracturing,” is a method used in the development of oil and gas. It is designed to increase access to trapped hydrocarbons. The method involves the introduction of quantities of “fracturing fluid” (usually comprising water, small particulate matter, and various chemicals) into a well bore. The fracture fluid is then forced, under pressure, into the geologic formation surrounding the well bore, with the particulate matter helping to keep the fissures and cracks open when the pressure is removed. These fissures and cracks act as conduits through which hydrocarbons trapped in the formation can travel into the well bore.

Hydraulic fracturing is useful when obtaining hydrocarbons from geologic formations with significant amounts of shale and/or clay. Shale and clay-rich formations may be referred to as “tight oil” formations. While tight oil formations, although they may contain large hydrocarbon reserves, those reserves are “trapped” in the formation and wells drilled into them do not produce significant amounts of hydrocarbon without the use of hydraulic fracturing. These formations can be found throughout the United States, for example in North Dakota (the Baaken Formation) and Texas (the Eagleford Formation). In many cases, the use of hydraulic fracturing has rendered these formations accessible to oil and gas development.

The use of hydraulic fracturing, which requires the injection of substantial volumes of fluid into the ground, has, in some cases, triggered environmental concerns. In particular, opponents of hydraulic fracturing have identified fracture fluids and their ingredients as potential environmental hazards. In response, the U.S. Environmental Protection Agency (EPA) has prohibited certain compounds from being used in hydraulic fracturing. One such banned compound is diesel fuel (e.g., No. 2 Diesel Fuel). Water use in hydraulic fracturing is also problematic. For example, the large volumes of water that may be required in hydraulic fracturing has raised concerns, especially in arid regions were water may not be in abundant supply. Further, the presence of water in hydraulic fracturing fluid can also cause damage to the well itself. For example, the presence of water has been found to swell clay found in some geologic formations. This swelling may render tight oil formations even tighter.

What is needed is an environmentally acceptable fluid composition for use in enhancing oil recovery, lowering the viscosity of heavy crude oils, hydraulically fracturing wells, and/or restoring oil production from wells with low production, for example water-damaged wells.

### SUMMARY

The disclosed compositions, processes, methods and systems are directed to the extraction of hydrocarbons from oil wells. In many embodiments, the disclosed composition may be an environmentally friendly composition. In one embodiment, the disclosed methods and compositions may be used to enhance recovery of oil from wells. The disclosed compositions, methods, and systems are useful in enhancing the flow of oil that may exhibit high viscosity. In some embodiments, the disclosed compositions and methods may be combined with other methods to enhance oil recovery from a well. In other embodiments, the disclosed method may be used in wells that have been drilled (or are being drilled) into or through clay formations. The disclosed compositions, methods, and systems are useful in restoring the flow of hydrocarbons from a well that has been hydraulically fractured with a fluid containing water. The disclosed compositions, methods, and systems may also be used as a fluid for fracturing a well in a formation containing clay.

Disclosed herein are compositions, methods, and systems for the treatment of reserves of high viscosity and/or trapped crude oil reserves. The disclosed compositions, methods, and systems may also be used to treat wells that have been damaged by the addition of a water-based hydraulic fracturing fluid (fracturing fluid). The disclosed compositions, methods, and systems may also be useful as a hydraulic fracturing fluid in wells which have been identified as being susceptible to being affected adversely by the addition of water as a tracking fluid. In both cases, significant increases in crude oil production will occur while remaining well within current EPA regulations.

Disclosed herein are fluid compositions for enhancing recovery of crude oil and/or gas from a geologic formation, the fluid comprising, 90% or greater methyl esters derived from plants or animals, or manufactured methyl esters of C1-C8; a basic compound or acid compound, wherein the base or acid is sufficient to increase or decrease the pH of the fluid to greater than or less than about 7.0 after about 1 hour. In some embodiments, the fluid composition further comprises, a viscosity-enhancing compound, which is selected from an amine and an aldehyde, for example a primary amine, glutaraldehyde, and/or formaldehyde. In some embodiments, the fluid composition may comprise a proppant, selected from citric acid or sodium hydroxide, and the acidic compound is phosphoric acid.

Also disclosed herein are methods of enhancing oil and/or gas recovery from a well comprising: injecting a fluid composition comprising 90% or greater methyl esters derived from plant or animals, or manufactured esters of C1-C8 into an injection wellbore; contacting the fluid with water in the wellbore, and extracting a second fluid from a production wellbore. In some embodiments, the injection and production wellbores are the same. In some embodiments the method further comprises combining a first viscosity-modifying compound with the fluid composition, or injecting the first viscosity-modifying compound into the wellbore after the fluid composition. In some embodiments, a second viscosity-modifying compound is injected into the wellbore after the first viscosity-modifying compound, which may be after the fluid composition is injected into the wellbore.

Also disclosed, are methods of producing a hydraulic fracturing fluid comprising: adding a gelling agent to a biodiesel fluid composition and/or manufactured fluid composition comprising methyl esters of C1-C8, wherein the gelling agent decreases the pH of the fluid; adding a breaker compound to the mixture of gelling agent and biodiesel or engineered fluid composition, the breaker compound being a base that increases pH over a period of greater than 30 minutes. In some embodiments, the gelling agent comprises phosphoric acid, and the biodiesel is a red color at pH greater than about 7.0 and is black color at pH less than about 7.0. Also disclosed are methods for increasing production of a hydrocarbon from a well, comprising: injecting a biodiesel product into a well that has been hydraulically fractured with a fluid containing water, the biodiesel product comprising at least one additive that is able to increase or decrease the pH to be greater than 8.0 or less than 6.0, the biodiesel product comprising greater than about 90% methyl esters derived from a plant or an animal; increasing the pressure of the biodiesel to greater than about 100 psi; allowing the biodiesel product to remain in the well for greater than 12 hours; pumping a flowback fluid from the well. In some embodiments, the biodiesel product further comprises a proppant, wherein the proppant further comprises an acid, and/or a gelling agent comprising phosphoric acid. In some embodiments, the methyl esters react with a water in the well to produce an alcohol.

### BRIEF DESCRIPTION OF THE DRAWINGS

FIG. 1 shows a tube containing one embodiment of the disclosed fluid compositions.

FIG. 2 shows flowback that has partially settled.

FIG. 3 shows flowback containing formation crude.

FIG. 4 shows production of water, oil, and gas from Well X described in Examples. The top graph shows initial production after completion of the well, and the bottom graph shows production after the well was treated with disclosed methods and compositions. The arrow indicates when the well was injected with the disclosed biodiesel composition.

### DETAILED DESCRIPTION

Disclosed herein are fluid compositions, methods, and systems for use in enhancing oil and/or gas recovery from reservoirs containing highly viscous oil, or oil that is otherwise difficult to extract. In some embodiments, the oil and/or gas may be difficult to extract due to a “tightening” of the geologic formation, for example due to water damage. The disclosed compositions and methods are useful in aiding the removal of water from the geologic formation, for example by helping to convert the water and esters added to the well into an alcohol and fatty acids. In some embodiments, the presence of methanol and/or other alcohols in the geologic formation may aid in removing water from the formation and transporting it into the flowback. Surprisingly, and as demonstrated in the Example Section, employing the disclosed methods and fluid compositions is able to restore oil and gas production on a well that had ceased to produce either after initially producing a peak of about 1,000,000 cubic feet (1,000 MCF) of natural gas per day. Specifically, after essentially ceasing to produce (about 50 MCF) for about three months, the disclosed compositions and methods enhanced this production nearly 10-fold, to about 350 MCF (350,000 cubic feet) of gas per day in just three months. Over four months, the disclosed methods and compositions restored nearly 40% of the well's original production. Estimates suggest that the disclosed methods and compositions may result in enhancement of the original 1,000 MCF production to 1.5-3.0× or more.

The compositions, methods, and systems may be useful in altering the chemical and/or physical properties of the oil and/or the geologic formation. The disclosed fluids, methods, and systems may be combined with one or more additional fluids, methods, and/or systems to enhance oil recovery. In many cases, the disclosed compositions, methods, and systems may aid in reducing the viscosity of crude oil and allow a greater percentage of the oil to be recovered from the reservoir than other methods of enhanced oil recovery. In some embodiments, the disclosed fluid composition may be referred to as biodiesel, and may comprise greater than about 90% biological-derived compounds.

The disclosed biodiesel, or bio-fluid composition may act as a solvent to enhance the reservoir oil's viscosity. In many cases, the disclosed fluid is a diesel product derived from plants or animals and comprising greater than about 70%, 75%, 80%, 85%, 90%, or 95% compounds derived from plants or animals. The fluid composition may be injected into a formation to aid in oil recovery. In some embodiments, the fluid composition may aid in reducing the viscosity of an oil in the borehole or formation. In some embodiments, the fluid may act as a solvent.

The disclosed fluid may be used in thermal- and or chemical-enhanced oil recovery. For example, the fluid may be heated prior to injection to aid in thermal recovery in hygroscopic formation. The disclosed fluid may aid in thermal enhanced oil recovery because it has a high vaporization temperature, heat content, and lacks water. In these embodiments, the disclosed fluid may allow for the use of thermal enhanced recovery methods in formations where steam injection may harm the formation.

The fluid composition may be combined with, injected prior to, and/or injected after one or more other viscosity-modifying fluids or other compounds. In some cases, the viscosity modifying fluids may comprise two fluids, one comprising of one or more amines (for example primary amines) and another fluid comprising one or more aldehydes, for example glutaraldehyde or formaldehyde, wherein reaction of the first and second viscosity modifying fluids is an exothermic reaction that may result in an increase in pressure within the borehole. In some embodiments, for example wherein the aldehyde is glutaraldehyde, the reaction of the first and second viscosity modifying fluids may result in formation of a compound that may aid in scavenging hydrogen sulfide from the formation.

Viscosity-modifying compounds may be injected sequentially into a wellbore. The amine may be pumped into the well before or after the aldehyde. In most cases, the two viscosity-modifying compounds may be separated by a volume of the claimed biodiesel composition. Separating the viscosity-modifying compounds may allow delaying the start of the exothermic reaction until the fluids mix in the well-bore. Injecting the bio-fluid composition into the formation before injecting the viscosity-modifying fluids may aid in enhancing oil recovery by forcing solvent into the formation and/or heating the solvent in the formation.

Thermal enhanced oil recovery methods, alone, are insufficient to improve recovery over a long period of time. While heat may be effective in reducing the viscosity of free oil, it may not, in many cases, be enough to mobilize the bound oil in formation such that it can be removed. Moreover, the effects of thermal techniques generally dissipate over time (as well as distance from the injection point), as the elevated temperatures drop. Additionally, when heating methods are used, paraffin deposition may result from pressure drops at the perforations. Over time, paraffin deposition may reduce conductivity. In these embodiments, the amine-based viscosity modifier may be combined with the disclosed fluid composition to reduce viscosity when the thermal effects dissipate. For example, addition of the amine-based viscosity modifier may allow for the effects of the exothermic reaction, chemical changes to the oil, and/or structural changes to the formation to persist for longer periods of time

Use of glutaraldehyde in the second viscosity-modifying compound may result in a post reaction fluid with high viscosity. This post reaction fluid may comprise triazine formed from reaction of glutaraldehyde and amine. In addition, paraffin may also be produced. This may be due to a pH change. However the use of formaldehyde instead of glutaraldehyde may result in a low viscosity oil that is capable of sequestering paraffin, and in many cases formaldehyde is less expensive than glutaraldehyde. In most cases, the majority of formaldehyde will be consumed in the reaction.

Addition of non-emulsifiers/surfactants to the biodiesel and viscosity-modifying compounds may allow oil viscosity to reach very low levels, such as less than about 1,000 cP, 500 cP, 100 cP, 50 cP, 40 cP, 30 cP, 20 cP, 10 cP, 5 cP, 4 cP, 3 cP, or 2 cP, and the stability may be maintained at about 40° F. (4.5° C.). The improved wettability of these embodiments may help to further increase oil recovery. In some cases, laboratory tests showed a 5% increase in recovery beyond the viscosity benefits as an improved fraction of the free hydrocarbon is recoverable. In some embodiments, increased recovery may correlate with the use of the disclosed biodiesel composition and its use may be as effective or more effective than heat alone. It is likely that use of the viscosity-modifying compounds enhance oil recovery, at least in part, by improving dispersion into the formation. In some embodiments, oil recovery may be enhanced by solvent addition. In other cases, solvent flooding may be combined with step-wise addition of viscosity-modifying compounds.

The combination of viscosity-modifying fluids with solvent treatment may allow for enhanced recovery of bound oil. In some embodiments, when testing dried core samples, combined solven+viscosity-modifier treatment may allow recovery of bound oil at a rate of greater than 2%, 3%, 4%, 5%, 10%, 20%, 30%, 40%, 50%, 60%, 70%, or 80% of the volume of the treatment fluid (solvent volume+amine fluid volume+aldehyde fluid volume) applied on the initial treatment. Subsequent treatments may recover reduced fractions of bound oil.

Also disclosed are compositions, methods, and systems for use in hydraulic fracturing of new wells and restoring production levels from previously fractured wells. The compositions, methods, and systems may aid in restoring productivity of wells that have been fractured in geologic formations with significant amounts of clay. The disclosed compositions aid in removing water from fractured wells in clay-containing formations and increasing the production of hydrocarbons from these formations. In many cases, the disclosed compositions, methods, and systems may aid in reducing the water content of clay that may have swelled during the fracturing process.

Using the disclosed compositions, methods, and systems may aid in preventing a reduction in hydrocarbon production from wells drilled through clay-rich formations and may also be used to rehabilitate formerly-productive, previously fractured wells in similar formations.

Hydraulic fracturing, in general, is cost intensive. First, the wells usually contain at least one horizontal section, drilled with the intent to be completed through the use of hydraulic fracturing techniques. Horizontal drilling requires sophisticated (and costly) equipment and techniques. In some cases, for example where the well is drilled within a formation with significant amounts of clay, the well may, initially, show significant production (e.g. during the first 1-2 days post-completion), but produce increasingly smaller amounts of hydrocarbon over time. In some cases, production from these wells may be reduced to 25% or less of the initial production, for example three days post-completion. In some cases, examination of drill core samples from these wells has shown that the clay within the drill zone swells in response to water exposure. This swelling can seal the very fissures, cracks, pores, and channels that the initial hydraulic fracturing was intended to produce, rendering them less able to or incapable of transporting hydrocarbons, thereby reducing production.

Clay is found in many hydrocarbon-rich geologic formations. In general, clay refers to small particles, usually about 2 microns or less, composed of aluminum silicates and various other compounds. Some clays are hygroscopic and can absorb large amounts of water. This absorption of water may cause the clay to swell (in some cases, increasing the volume of the clay by about 100%). Some examples of clays that swell significantly in response to the absorption of water include bentonite and montmorillonite.

Disclosed herein is a composition for use in hydraulic fracturing a new well or restoring a previously hydraulically-fractured well that has, over time, substantially reduced production of hydrocarbons. The disclosed composition comprises plant- and/or animal-derived hydrocarbons, for example alkyl esters, preferably methyl esters, which are permitted for use in fracturing fluid by the U.S. EPA. In many embodiments, the composition may have a pH that may change over time, for example the pH may be acidic when the composition is injected into a bore-hole, and later become basic. The composition may also comprise other additives, for example a gelling agent, breaking agents, colorant, sand, citric acid.

The disclosed composition may also be used in methods of restoring or rehabilitating a well, located in or near a formation with substantial clay. In many embodiments, the well is producing less hydrocarbons than when it was first fractured. In one embodiment, the clay surrounding the well may have a pH that is greater than about 7.0. The disclosed methods may aid in increasing or restoring hydrocarbon production from these wells.

Also disclosed herein are methods for using the disclosed composition as a hydraulic fracturing fluid for use in a well that has not been previously fractured. In many embodiments, the disclosed composition may be used to fracture a well bore located in a geologic formation with substantial concentrations of clay. In these cases, the disclosed fluid composition may aid in preventing or reducing the post-hydraulic fracturing reduction in hydrocarbon production experienced with water-based hydraulic fluids.

In some embodiments, it may be beneficial to examine a core sample from the well for the presence and identity of clay in the formation. Where the clay present in the core sample swells in the presence of water, the ability of the disclosed composition to reverse swelling may be tested. For new wells that have not been fractured previously, the disclosed composition can be used to help prevent or minimize a loss in production due to water-swelled clay. For wells that have been previously fractured, and that have demonstrated reduced hydrocarbon production over time, the disclosed composition may be injected into the well and allowed to migrate into the surrounding formation. After restoring better hydrocarbon flow from the well, the composition can be removed from the well, treated, and re-used.

Without wishing to be limited by a specific mechanism of action, the disclosed fluid composition may consume water and create an alcohol (for example an linear or branched C₁-C₈ alkyl alcohol such as methanol, ethanol, propanol, isopropanol), this may also produce a free fatty acid. The production of methanol produced by the reaction may aid in restoring production. Methanol may be volatilized at high temperatures (for example those within a well bore or the surrounding formation—i.e. the target zone). The production of methanol within the formation may increase the pressure within the target zone, leading to additional fracturing of the formation and/or allowing proppant into the surrounding formation. In some cases, free fatty acids may react with acid in the fluid to produce a fatty acid salt, or soap molecule.

In some embodiments, additional compounds may be added to the composition. In many embodiments, a base or an acid (for example, sodium methylate or sodium hydroxide or methanesulfonic acid or hydrochloric acid) may be added to the fluid composition before or after introduction into the well bore. The addition of a base to the fluid composition may aid in raising or lowering the pH such that it is greater or less than 7.0, for example greater than about 8 or less than 6. In many embodiments, the base or acid may not raise or lower the pH immediately, but may increase or lower the pH over time. The presence of a base or acid may aid in allowing one or more chemical reaction(s) to occur.

The disclosed compositions and methods may result in reducing the amount of water bound to clay (i.e. dehydrating the clay) within the target formation. In some embodiments, this dehydration may occur simultaneously with increasing the concentration of one or more alcohol (for example methanol) in the target formation. Methanol, which is miscible in water, may aid in removing water from the formation and into the fluid composition.

### Biodiesel-Based Fluid

The disclosed fracturing fluid compositions contain methyl esters produced from the esterification/transesterification of plant-based and animal-based organic fats and oils. These methyl esters, commonly referred to as biodiesel, are deemed acceptable for use in hydraulic fracturing. As used herein, “biodiesel” may refer to fluid compositions comprising predominantly esters (e.g. alcohol-based esters, including propyl and methyl esters), and may or may not include industry or governmental standards, for example eASTM 6751. In some embodiments, the disclosed composition includes additional chemicals, compounds, and additives that are deemed by the U.S. EPA to be safe for use in hydraulic fracturing. In many embodiments, the disclosed composition comprises greater than 90% biodiesel, or greater than 95%, 96%, 97%, 98%, or 99% biodiesel.

Disclosed herein is a manufactured biodiesel based on esters with less than about 8 carbons. Typically, biodiesel from plant and animal sources are dominated by C8-C20 chain esters. In some embodiments, the manufactured biodiesel fluids comprising methyl esters may be obtained by reacting short chain fatty acids with an alcohol such as methanol or propanol. In some embodiments, the fatty acid may be one or more of a C1-C5 fatty acid. In some embodiments, the fatty acid is selected from acetic acid, lactic acid/propionic acid, and butyric acid. In some embodiments, the selection of one or more fatty acid may be based on characteristics such as melting point, boiling point, and solubility in water. For example, propionic acid has a melting point of −22° C., a boiling point of 141° C., and miscibility in water (>5 g/100 g water). In many embodiments, the fatty acid is also soluble in oil, i.e. is amphiphilic. In many embodiments, the alcohol is selected from a C1-C8 alcohol. In some embodiments, the alcohol used to esterify the fatty acid is selected from methanol and/or propanol. In many embodiments, the esters produced from these reactions behave as well as or better than methyl esters obtained by transesterification of animal and plant sources (typically C8-C20). In some embodiments, the manufactured esters may help to remove water from a formation more quickly than a similar amount of biodiesel.

The disclosed compositions and fluids may have typical colors, viscosity, pH etc. In many embodiments, the disclosed fluid may be clear, yellow, orange, red, or combinations thereof, e.g. orange-red, with a viscosity similar to water with a solvent feel to the hands. In some embodiments, the disclosed fluids may have a viscosity from about 1.3 to 6.7 centistokes (mm²/s) at 40° C. In many embodiments, the kinematic viscosity is between about 1.9-6.0, or 3.5 and 5.0, or may be less than about 7.0, 6.5, 6.0, 5.5, 5.0, 4.5, 4.0, 3.5, 3.0, 2.5, 2.0, or 2.0, and greater than about 1.5, 1.7, 1.8, 2.0, 2.5, 3.0, 3.5, 4.0, 4.5, 5.0, 5.5, 6.0, or 6.5.

The disclosed fluid may include one or more additional compounds, chemicals, and/or additives. In some embodiments, the disclosed fluid may include a visual pH indicator, for example a colorant. In some embodiments, the colorant may cause the composition to be a first color if the pH is basic (greater than about 7.0) and a second color if it is acidic (less than about 7.0). In one embodiment, when the fluid is basic, the color is red or pink, and when the fluid is acidic, the color is black.

The disclosed fluid may include an inert compound. In some embodiments, the inert compound may be a particle or a gas, for example nitrogen. An inert gas may help increase the volume of the fluid, allowing less of disclosed fluid to be used. In some embodiments, the presence of nitrogen may allow the composition to be a foam. Solid particles may be added to the disclosed fluid, for example proppants. In many cases, the proppant may be sand or a ceramic particle. The proppant may aid in maintaining fissures or cracks in an open confirmation. In some embodiments, the proppant may include voids where one or more compounds or chemicals may be placed. In many embodiments, the proppant may further include an acid, for example citric acid and/or sodium hydroxide.

The disclosed fluid may include one or more compounds to aid in modifying the fluid's viscosity. In most cases, the viscosity of the fluid may change over time. For example, the fluid may decrease in viscosity over time, such that it may be more viscous when it is first injected into a well then less viscous when it is removed from the well. The viscosity of the fluid may be increased by the addition of a gelling agent. In one embodiment, the gelling agent is acidic, and may include, for example phosphoric acid. In some embodiments, the gelling agent may include one or more additional compounds, for example a salt, for example a potassium salt.

The disclosed fluid may further include a compound that reduces the viscosity. In most embodiments the viscosity-reducing compound is a base that may increase the pH of the fluid over time. In some embodiments, the compound for reducing viscosity may be referred to as a breaker.

The disclosed fluid composition may include one or more additives that may aid in reducing the concentration of fatty acid salts (or “soaps”). In some embodiments, free fatty acids may be formed with formation of methanol. Fatty acids combined with a base such as sodium hydroxide may lead to the production of salts of the fatty acids, which may be referred to as soap. Soap molecules may coalesce and precipitate out of solution and/or coat surfaces within the well, this may be undesirable. In some cases, an acid may be added to the disclosed fluid to help reduce formation of soap molecules. Addition of an acid may aid in converting the soap into a free fatty acid. In some cases, the acid may be added to the fluid as an encapsulated acid. The encapsulated acid may react with a soap molecule to create a free fatty acid. In some embodiments, the acid may be citric acid. In some embodiments, the citric acid may be encapsulated in a silicon dioxide particle.

### Affected Zone

As used herein, an “affected zone” is an area around a bore hole that has been damaged by one or more completion processes. In some embodiments, the affected zone is a region near a bore hole that contains one or more clays that have absorbed water from one or more treatments of the well, for example hydraulic fracturing.

Method of Removing Water from a Geologic Formation

Introducing the disclosed compositions may, in some embodiments, aid in generating one or more chemical reactions within the geologic formation, especially at or near the well bore. In some embodiments, the chemical reactions may result in the release of energy, which may be sufficient to create fissures and/or cracks (e.g. micro fissures) in the affected zone The reaction may also create various compounds, including alcohols (for example, methanol, isopropanol, etc.), fatty acids (e.g. stearates, acetates, etc), and salts thereof. The resulting compounds, and their unique interaction with water (particularly of methanol/isopropanol), may help to “dry out” specific types of clays which have swelled due to contact with water.

Without wishing to be limited by theory, the generalized reaction that is used to extract water from the affected zone is shown below. In this generalized equation, the methyl esters are depicted reacting with water to create a fatty acid and methanol. In the equation R may be a saturated or unsaturated aliphatic obtained from natural sources (in one embodiment biodiesel), or manufactured (as described above). In addition, as discussed elsewhere, the reaction may, in some embodiments result in formation of other alcohols (in one embodiment propanol).

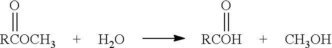

The disclosed compositions and methods help to extract water that may have damaged a well. In many embodiments, injection of the disclosed compounds and fluids may allow for extraction of water and one or more of an alcohol, fatty acid, or salt thereof (e.g. methanol, isopropanol, stearate (sodium stearate/potassium stearate), and acetate from the well first. This may aid in increasing the porosity and permeability of the surrounding formation. When porosity and permeability have improved, the extracted product will transition to oil or gas and production rates will increase.

The disclosed method of injecting methyl ester uses commonly accepted injection methods well known to those of skill in the art. In many embodiments, the disclosed fluid is injected into the zone of interest. The fluid may be pressurized to allow the fluid to leave the borehole and contact the clay. Prior to injection, it may be beneficial to analyze the zone carefully to determine if the characteristics of the clay are compatible with the disclosed fluid compositions and methods. For example, an acidic clay may, in some cases, be incompatible with the disclosed methods. In these cases, the clay may be treated with a base to increase the pH of the clay.

The disclosed methods may include pressurizing the fluid composition in the well. The pressure of the fluid within the well may be increased, for example to greater than about 20 psi, 30 psi, 40 psi, 50 psi, 60 psi, 700 psi, 80 psi, 90 psi, 100 psi, 110 psi, 120 psi, 130 psi, 140 psi, 150 psi, 160 psi, or more.

The disclosed fluid may remain within the bore-hole for a period of time to allow it to react with the water in the bore-hole and surrounding affected area. In some cases, the fluid remains within the well for greater than about 12 hours, 24 hrs, 36 hrs, 48 hrs, or more. In some embodiments, the fluid remains in the well for between about 2 and 4 days.

Dehydration of the clay by the disclosed fluid may be enhanced by elevating the temperatures and/or pressures within the well. In many embodiments, the dehydration reaction may also be enhanced by increasing or decreasing the pH of the fluid. The reaction may also be enhanced where the clay has a pH of greater or less than 7.0, for example greater or less than about pH 8.0 or pH 6.0. In some embodiments, the reaction may be aided by addition of one or more basic or acidic compositions to the fluid composition. This may aid in increasing or decreasing the pH of the fluid composition to greater than about 8.0 or less than about 6.0. In many embodiments, the base or acid does not immediately increase or decrease the pH, but raises or lowers the pH over a period of time. This increase or decrease in pH may be accompanied by a decrease in viscosity. In some embodiments, the base or acid may be referred to as a breaker, and the breaker may raise or lower the pH over a period of from about 10 minutes to 60 minutes.

The disclosed fluid composition may be used in a method or process of reducing the amount of water in a geologic formation, for example a formation surrounding a previously hydraulically fractured well. In some embodiments, the disclosed method includes injecting the disclosed fluid into the well and increasing the pressure of the fluid within the well. The method may further include allowing the disclosed fluid to invade the surrounding formation. The method may further include allowing the disclosed fluid to remain in the formation for a period of time, for example from about 12 hours to about 84 hours. The method may further include removing the disclosed fluid from the well, wherein the disclosed fluid may include, as discussed above, methanol and soap. In some embodiments, an acid solution may be injected into the well to aid in dissolving one or more soaps that may remain the well.

The disclosed methods may include additional steps that may enhance removal of water from the formation. For example, in some embodiments the fluid may be mixed with a gas to create a foam. In some embodiments, the gas may be nitrogen case. In some embodiments, the fluid may comprise one or more foaming agents well known to those in the art, selected from one or more of alkyl ether sulfates, alkyl sulfates, amine oxides, betaines, fluorosurfactant, and olefin sulfonates. In one embodiment, the foaming agent is a fluorosurfactant. In some embodiments, the fluid may have a higher viscosity when first injected into the well, than when removed from the well. In some embodiments, the viscosity of the disclosed fluid may be modified with one or more gelling and/or breaking agents.

The disclosed methods and compositions may help to restore or enhance oil or gas production of a well. In some embodiments, production, after treating the well, may increase 2-30×, for example more than about 1.5×, 2×, 3×, 4×, 5×, 6×, 7×, 8×, 9×, 10×, 11×, 12×, 15×, 20×, 25×, 30×, 40×, 50×, 60×, 70×, 80×, or 90×, and less than about 100×, 90×, 80×, 70×, 60×, 50×, 40×, 30×, 20×, 15×, 10×, 9×, 8×, 7×, 6×, 5×, 4×, 3×, or 2×. In some embodiments, the disclosed methods and compositions may aid in restoring production of a well that had previously produced acceptable quantities of oil and/or gas. In some embodiments, the disclosed methods and compositions may restore production to between 20% and 200% of original production (which may be calculated from a single day or an average of several days when the well was first fully operational). In some embodiments, restoration of production may be greater than 1%, 5%, 10%, 15%, 20%, 30%, 40%, 50%, 60%, 70%, 80%, 90%, 100%, 110%, 120%, 130%, 140%, 150%, 200%, or 300% of original production, and less than about 300%, 250%, 200%, 150%, 140%, 130%, 120%, 110%, 100%, 90%, 80%, 70%, 60%, 50%, 40%, 30%, 20%, 15%, 10%, 5%, or 2%.

In some embodiments, restoration and/or enhancement may require between 1 and 20 weeks, or more. In some embodiments, restoration and/or enhancement may stabilize after about 3 months. In some embodiments, one or more subsequent treatments with the disclosed compositions may help in restoring or enhancing the well's productivity.

### Treated Well

As disclosed herein, a treated well is a well that has been injected with one or more of the disclosed compositions and fluids. In many embodiments, a treated-well produces more oil and/or gas than the same well immediately prior to treatment. In some embodiments, as disclosed in the examples, the treated well may or may not produce as much oil and/or gas on a given day after treatment than that well produced when first drilled. In some embodiments, a treated well has been injected (i.e. treated) more than once with the disclosed methods, compositions, and fluids.

### Flowback

Flowback may refer to the fluids and compositions discharged, or extracted from a well after treatment with the disclosed fluids and compositions. In some embodiments flowback may have a color and viscosity similar to that of the disclosed fluid (clear, yellow, orange, red, and combinations thereof). In many embodiments, as shown in FIG. 2, the flowback is cloudy upon exiting the well. In some embodiments, flowback may comprise one or more waters, alcohols, fatty acids, stearates, and salts thereof (for example sodium, calcium, magnesium, potassium, etc. salts). In some embodiments, stearate salts may be referred to as soaps. In some embodiments, soaps in the flowback may indicate a formation with basic (>7.0 pH), or a drop in well pressure and/or temperature.

The concentration of soap in the flowback may be addressed or mitigated by injecting one or more additives into the treated well. In some embodiments, an acid (for example an organic acid) can be injected to react with the soap molecules to form fatty acids. In some embodiments, a salt (e.g. NaCl, etc.) can be added to “soften” the soaps, allowing them to flow more easily. In many embodiments, the flowback may comprise calcium, magnesium, and/or phosphoric salts which may combine with the stearates to form insoluble calcium or magnesium stearate. The addition of Na ions (in the form of NaCl) may compete with and replace the Mg and Ca with Na ions, rendering the soaps soluble again. In some embodiments, soap formation may be reduced, controlled, or mitigated by substantially preventing pressure reductions and an accompanying lowering of the temperature of the fluids.

Flowback may comprise significant amounts of alcohol, for example methanol, or isopropyl alcohol. In some embodiments, flowback may comprise from 0.01-5% alcohol. In many embodiments, the amount of alcohol in the flowback may be greater than about 0.01%, 0.5%, 0.6%, 0.7%, 0.8%, 0.9%, 1.0%, 1.1%, 1.2%, 1.3%, 1.4%, 1.5%, 1.7%, 1.9%, 2.0%, 2.5%, 3.0%, 3.5%, 4.0%, or 4.5%, and less than about 10%, 5.0%, 4.5%, 4.0%, 3.5%, 3.0%, 2.0%, 1.9%, 1.8%, 1.7%, 1.6%, 1.5%, 1.4%, 1.3%, 1.2%, 1.1%, 1.0%, 0.9%, 0.8%, 0.7%, 0.6%, 0.5%, 0.4%, 0.3%, 0.2%, 0.1%, or 0.5%.

Flowback may comprise one or more fluids from the formation, for example crude, water, or gas. As shown in FIG. 3, flowback may, after being allowed to settle, stratify into three or more layers. The layers may comprise formation crude, fatty acids, and water/methanol.

### Hydrocarbon

A hydrocarbon, as used herein is any organic chemical compound composed exclusively of hydrogen and carbon atoms, and extracted/obtained from a geologic formation. In many cases, hydrocarbons refers to liquids and gasses, for example crude oil and gas, such as natural gas, which may be predominantly methane.

### Prophylactic Use

The disclosed fluids and compositions may be used to prevent damage to wells during the fracturing process and/or may aid in recovering fluid from the well. In some embodiments, the disclosed compositions and fluids may be injected into a well-bore prior to hydraulic fracturing. In some embodiments, the disclosed fluids may be injected into the well, followed by injection of an inert gas, for example nitrogen. In some embodiments, a hydraulic fracturing fluid comprising water and a proppant may be injected after the nitrogen injection, at high pressure to stimulate oil and or gas production. In many embodiments, the prophylactic use of the disclosed compositions and fluids may aid in preventing damage to the formation caused by water in the fluid and or may aid in recovering fracturing fluid from the well, thereby enhancing productivity when compared with stimulation without the disclosed compositions and fluids. [I understand this process is still in development, but I want to describe it sufficiently to protect the basic idea in this application.]

### Re-Generation of the Disclosed Biodiesel Fluid

In some embodiments, after the disclosed fluid has been used to dehydrate the formation, the fluid may be processed to recreate the methyl esters so that they may be re-injected into the same bore hole or a second bore hole. In some embodiments, recaptured methyl esters and soaps may be collected from a bore hole, separated from one or more hydrocarbons or other compounds, and then subjected to acidulation, esterification and transesterification to regenerate methyl esters. In some embodiments, the sodium hydroxide, sodium methylate or other bases may be added to the collected fluid to increase the pH of the hydrocarbon/methyl ester mixture to greater than about 13. In some embodiments, water may also be added to the collected mixture in the amounts of 5 to 15% of the volume of the total volume. In some embodiments, agitation may aid in the regenerating the methyl esters. The agitation (passive or active, for example mechanical) may aid in mixing the collected fluid and additives. The mechanical agitation may be performed for 30-60 minutes at a temperature, which may be between 30 and 75° C. After the agitation step, the solution may be allowed to stabilize and separation may occur over a period of time, which may be 1 to 12 hours. In some embodiments, a self-cleaning high-speed disk stack centrifuge may be used to separate the water-soluble soaps from the non-water soluble crude oil. Soaps, which have been separated from the crude oil, may, in some cases, contain various compounds that should be isolated and/or removed before further processing. After separating the soaps, one or more acids such as HCl, sulphuric acid, or an organic acid such as methanesulfonic acid can be added to the soaps to aid in producing free fatty acids and water. In some embodiments, this acidulation process may be necessary in order to perform esterification/transesterification and subsequent production of methyl esters for reuse in the methods and systems disclosed herein.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### EXAMPLES

### Well X

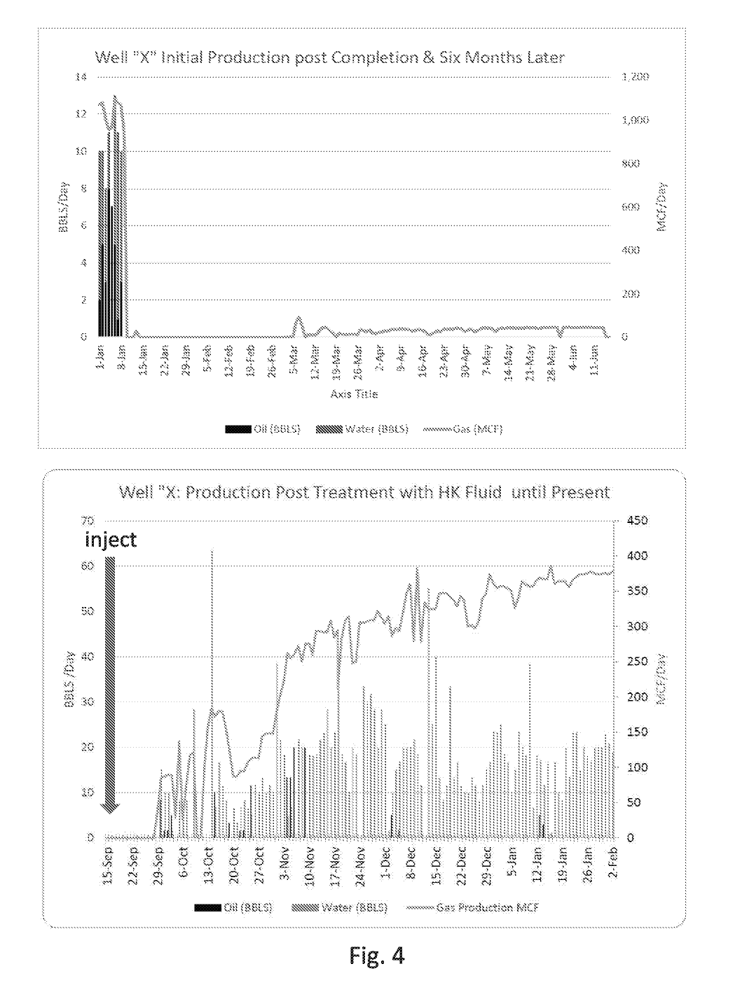

Well X is located in a formation having high content sandstone with content smectite and mixed-layer illites. Completion of Well X included the use of a water-based drilling mud and 1,795 k barrels of water-based fracturing fluid. Initial production, post-completion, from Well X was approximately 1,100,000 cubic feet (or about 1,100 MCF) per day (See FIG. 4, top). Thereafter, a casing leak deposited an unknown amount of water into the formation. Production dropped to nearly zero and thereafter increased to an average 25 MCF/day.

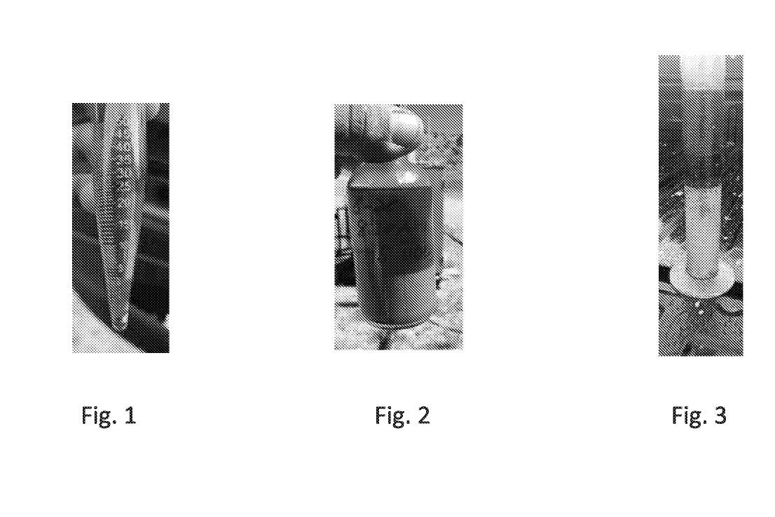

Approximately 250 days after completion of Well X, Applicants injected one embodiment of the disclosed fluid compositions into the well (FIG. 1). Specifically, approximately 280 barrels of a methyl ester composition comprising an acid and a foaming agent was co-injected with about 500 k standard cubic feet (scf) of nitrogen gas, under pressure into Well X (4.7 k psi). After introduction of the disclosed fluid composition, Well X was shut in at 1.2 k psi ISID. Over the approximately two weeks an unknown amount of gas was recovered along with about 250 barrels of flowback fluid. Initially the flowback was nearly 100% dark colored liquid (likely comprising the disclosed fluid compositions), and then transitioned to various combinations of colored liquid, water, oil, emulsion, and fines. On approximately day 12, post-treatment, flowback percentages were: 38% water, 44% emulsion, and 18% oil. Gas was produced in marketable quantities after about 14 days and production increased over the next approximately 4 months to about 400 MCF/day (FIG. 4; bottom graph). Table 1, below, shows analysis of the gas being collected approximately 14 days post-treatment demonstrating the majority is natural gas.

TABLE 1
Gas analysis

| Component | Mol % | Wt % | LV % |
|---|---|---|---|
| Methane | 89.1917 | 78.8086 | 87.5167 |
| Ethane | 3.1887 | 5.2809 | 4.9500 |
| Propane | 0.8168 | 1.9837 | 1.3037 |
| Isobutane | 0.2289 | 0.7328 | 0.4337 |
| n-Butane | 0.2602 | 0.8329 | 0.4751 |
| Neopentane | 0.0049 | 0.0194 | 0.0108 |
| Isopentane | 0.1525 | 0.6061 | 0.3234 |
| n-Pentane | 0.1179 | 0.4685 | 0.2474 |
| 2,2-Dimethylbutane | 0.0069 | 0.0328 | 0.0167 |
| 2,3-Dimethylbutane | 0.0174 | 0.0825 | 0.0412 |
| 2-Methylpentane | 0.0506 | 0.2400 | 0.1215 |
| 3-Methylpentane | 0.0325 | 0.1541 | 0.0767 |
| n-Hexane | 0.0600 | 0.2849 | 0.1429 |
| Heptanes | 0.2031 | 1.0543 | 0.4689 |
| Octanes | 0.0084 | 0.0524 | 0.0238 |
| Nonanes | 0.0019 | 0.0108 | 0.0043 |
| Decanes plus | 0.0000 | 0.0000 | 0.0000 |
| Nitrogen | 4.9467 | 7.6322 | 3.1414 |
| Carbon Dioxide | 0.7109 | 1.7231 | 0.7018 |

Over this 4 month period, approximately 2,000 barrels of flowback was recovered from Well X and about 35,000 MCF. The flowback composition varied over time. Initially flowback fluid comprised mostly water, biodiesel, formation crude, and between about 0.5 and 10% methanol. The methanol concentration of the flowback fluid recovered from the well has decreased to about 2% over the 4 month period. Gas production continues to progress as water recovery continues.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A fluid composition for enhancing recovery of a hydrocarbon from a geologic formation, the fluid comprising:
90% or greater methyl esters derived from one or more of plants, animals, synthetic sources;
an acidic compound; and
a basic compound, wherein the basic compound or the acidic compound is sufficient to increase or decrease the pH of the fluid composition to greater than or less than about 7.0 after about 1 hour.

2. The fluid composition of claim 1, further comprising a viscosity-enhancing compound.

3. The fluid composition of claim 2, wherein the viscosity-enhancing compound is selected from an amine and an aldehyde.

4. The fluid composition of claim 2, wherein the viscosity-enhancing compound is a primary amine.

5. The fluid composition of claim 2, wherein the viscosity-enhancing compound is selected from glutaraldehyde and formaldehyde.

6. A method of enhancing hydrocarbon recovery from a well comprising:
injecting a fluid composition comprising 90% or greater methyl esters derived from source selected from one or more of plants, animals, and synthetic material into an injection wellbore;
extracting a flowback fluid from a production wellbore.

7. The method of claim 6, wherein the injection wellbore and production wellbore are the same.

8. The method of claim 6, wherein a first viscosity-modifying compound is injected into the wellbore after the biological-based fluid.

9. The method of claim 6, wherein a second viscosity-modifying compound is injected into the wellbore after the first viscosity-modifying compound.

10. The method of any of claim 9, wherein the injection of the first and second viscosity-modifying compounds is separated by injection of fluid composition lacking the first and second viscosity-modifying agent.

11. The fluid composition of claim 1 for use as a hydraulic fracturing fluid further comprising a proppant.

12. The fluid composition of claim 11, wherein the proppant comprises citric acid or sodium hydroxide.

13. The fluid composition of claim 11, wherein the acidic compound comprises phosphoric acid.

14. A method of producing a hydraulic fracturing fluid comprising:
combining a gelling agent and a biodiesel fluid to create a mixture, wherein the gelling agent decreases the pH of the biodiesel fluid; and
adding a breaker compound to the mixture of gelling agent and biodiesel, the breaker compound being a base that increases pH over a period of greater than 30 minutes.

15. The method of claim 14, wherein the gelling agent comprises phosphoric acid.

16. The method of claim 14, wherein the biodiesel is a red color at pH greater than about 7.0 and is black color at pH less than about 7.0.

17. The method of claim 6, wherein the well has been hydraulically fractured with a fluid containing water, wherein the fluid composition comprises at least one additive that is able to increase or decrease the pH to be greater than 8.0 or less than 6.0;
further comprising the steps of
increasing the pressure of the fluid composition within the well to greater than about 100 psi;
allowing the fluid composition to remain in the well for greater than 12 hours; and
wherein the extracting step is performed by pumping the fluid composition from the well.

18. The method of claim 17, wherein fluid composition further comprises a proppant, wherein the proppant further comprises an acid.

19. The method of claim 17, wherein the biodiesel further includes a gelling agent comprising phosphoric acid.

20. The method of any of claim 17, wherein the methyl esters react with a water in the well to produce an alcohol comprising one or more of methanol and propanol.
